(19) United States
(12) Patent Application Publication
(10) Pub. No.: US 2008/0238586 A1
(43) Pub. Date: Oct. 2, 2008

(54) Controlled Impedance Radial Butt-Mount Coaxial Connection Through A Substrate To A Quasi-Coaxial Transmission Line

(76) Inventors: John F. Casey, Colorado Springs, CO (US); Donald E. Schott, Colorado Springs, CO (US); Thomas L. Mulcahy, Colorado Springs, CO (US); Ling Liu, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/693,347

(22) Filed: Mar. 29, 2007

(51) Int. Cl. H01P 5/08

(52) U.S. Cl. 333/260

(57) ABSTRACT

A solution to the problem of creating a controlled impedance coaxial connection to a quasi-coaxial transmission line at a location interior to a substrate and not along an edge is to radially butt-mount the connector to via-like structure on the backside of the substrate. By butt-mounting we mean that the connector itself does not extend into the substrate, but is attached to its surface. The via-like structure includes a conductor that extends through the substrate and into the confines of the quasi-coaxial transmission line proper, where it electrically connects to the center conductor of the quasi-coaxial transmission line. The butt-mounting of the coaxial connector may be accomplished with solder or conductive epoxy.

### REFERENCE TO RELATED PATENTS

U.S. Pat. No. 6,255,0730 B1 (issued 3 Jul. 2001 to Dove, Casey and Blume and entitled INTEGRATED LOW COST THICK FILM RF MODULE) describes various thick film techniques that become possible with the recent advent of certain dielectric materials. These are KQ-120 and KQ-CL907406, which are products of Heraeus Cermalloy, 24 Union Hill Road, West Conshohocken, Pa. Hereinafter, we shall refer to these products as the “KQ dielectric,” or as simply “KQ.” In particular, that patent describes the construction of an “encapsulated” microstrip transmission line.

This Disclosure concerns further novel and useful thick film techniques pertaining to an encapsulated coaxial transmission line of the sort described in U.S. Pat. No. 6,457,979 B1(issued 1 Oct. 2002 to Dove, Wong, Casey and Whiteley and entitled SHIELDED ATTACHMENT OF COAXIAL RF CONNECTOR TO THICK FILM INTEGRALLY SHIELDED TRANSMISSION LINE ON A SUBSTRATE, and which itself incorporates U.S. Pat. No. 6,255,730 B1), that may be practiced with these KQ (and other) dielectric materials.

Accordingly, for brevity and the sake of completeness, U.S. Pat. Nos. 6,255,730 B1 and 6,457, 979 B1 are each hereby expressly incorporated herein by reference.

### INTRODUCTION AND BACKGROUND

The reasons for using transmission lines to convey high frequency signals are many and well known. As higher and higher frequencies are employed it is also increasingly likely that increasing degrees of integration are used to fabricate the associated circuitry. It is not, however, the case that this is always accomplished within the confines of a single die or piece of semiconductor material (that is, within one Integrated Circuit, or IC); it remains the case that the “hybrid” circuit consisting of a substrate with various thick film structures thereon that are interconnected with a plurality of ICs is a desirable technique. So it is that we find high frequency hybrids that include transmission line structures fabricated upon the substrate thereof; such transmission lines have become an important way of conveying signals from one IC on the hybrid to another. We are particularly interested in the case when the transmission line is of the “quasi coaxial” type described in the incorporated '979 patent. By the term “encapsulated” the earlier '730 patent means that the transmission line, which in their example is what would otherwise be called a microstrip, is fully shielded, with a ground completely surrounding the center conductor. Its evolution into what is shown in '979 is not exactly what we would ordinarily term a “coaxial” transmission line, since its cross section does not exhibit true symmetry about an axis; it has a line and a rectangular trapezoid for a cross section instead of a fat point and surrounding circle. Nevertheless, we shall find it appropriate and convenient to call them (the ‘encapsulated’ transmission lines of the '730 B1 and '979 B1 patents) ‘quasi-coaxial’ transmission lines, which, it should be noted, can be pretty small (perhaps 0.050″ wide by 0.010″ or 0.015″ high, which makes the otherwise diminutive 0.100″ diameter RG 174/U seem large in comparison).

Sometimes the signals carried by these quasi-coaxial transmission lines must enter or leave the hybrid substrate, and this almost certainly means that some sort of coaxial connector of the controlled characteristic impedance variety is required. The transition, or ‘launch,’ between a connector of controlled characteristic impedance (say, 50Ω) and its associated transmission line (of the same characteristic impedance) is a delicate business, which if not done with care can create discontinuities that interfere with the integrity of the signal. So, for example, the '979 B1 patent deals with a way to create an ‘end launch’ using a conventional SMA edge mounted connector intended for use with a printed circuit board that is much thicker than a normal hybrid circuit and its substrate. By its very nature, that solution has to have an edge to be mounted upon. In cases where an edge is not available, it is known to radially mount in a hole through the substrate a suitable (e.g., SMA or a similar push-on style) controlled impedance RF [Radio Frequency] connector. The connector's axis is then perpendicular to the substrate and the plane of the quasi-coaxial transmission line, and the connector's center conductor is then wire-bonded to the center conductor of the quasi-coaxial transmission line. It is not so much that this never works for any application, but since the wire bond is not a controlled impedance, it is thus an objectionable discontinuity that interferes with high frequency operation, and is therefore an unsuitable technique for certain applications.

There are instances where the layout of the circuit requires that a high frequency signal enter or leave a quasi-coaxial transmission line that is part of the assembly, but to do so from a location interior to the perimeter of the substrate: that is, from a location not on an edge. For high frequency operation such a connection ought to be not simply shielded, but also have a controlled characteristic impedance that matches that of the transmission lines involved. What to do?

### SIMPLIFIED DESCRIPTION

A solution to the problem of creating a controlled impedance coaxial connection to a quasi-coaxial transmission line at a location interior to a substrate and not along an edge is to radially butt-mount the connector to via-like structure on the backside of the substrate. By butt-mounting we mean that the connector itself does not extend into the substrate, but is attached to its surface. The via-like structure includes a conductor that extends through the substrate and into the confines of the quasi-coaxial transmission line proper, where it electrically connects to the center conductor of the quasi-coaxial transmission line. The butt-mounting of the coaxial connector may be accomplished with solder or conductive epoxy.

### BRIEF DESCRIPTION OF THE DRAWINGS

FIG. 1 is a cross sectional view of a prior art quasi-coaxial transmission line of interest to the practice of the present invention;

FIG. 2 is a stylized side view of a prior art technique for providing an unshielded radial coaxial connection to one end of a quasi-coaxial transmission line, such as the one shown in FIG. 1;

FIG. 3 is a stylized side view of a shielded radial coaxial connection made at one end of a quasi-coaxial transmission line with a butt-mounted coaxial connector;

FIGS. 4A-M illustrate processing steps that may be used to fabricate the shielded coaxial connection of FIG. 3; and

FIGS. 5A-F illustrates optional steps for that may be practiced when the substrate and the deposited dielectric materials of FIGS. 4A-M are quite dissimilar in their rates of ablation during drilling operations with a laser.

### DETAILED DESCRIPTION

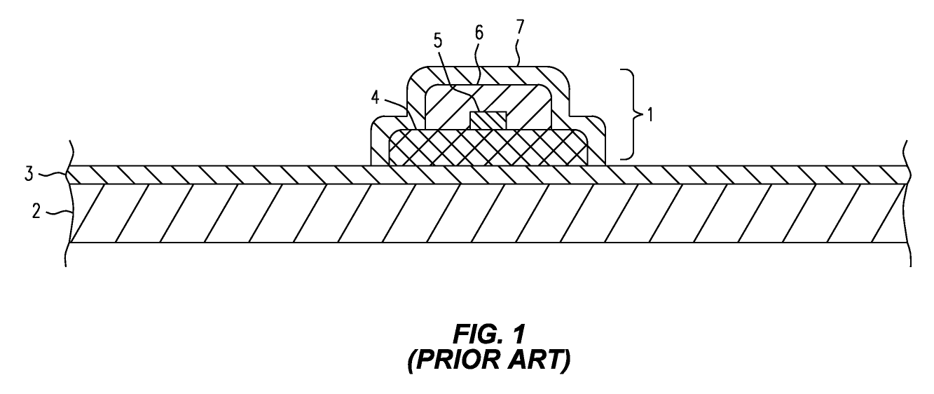

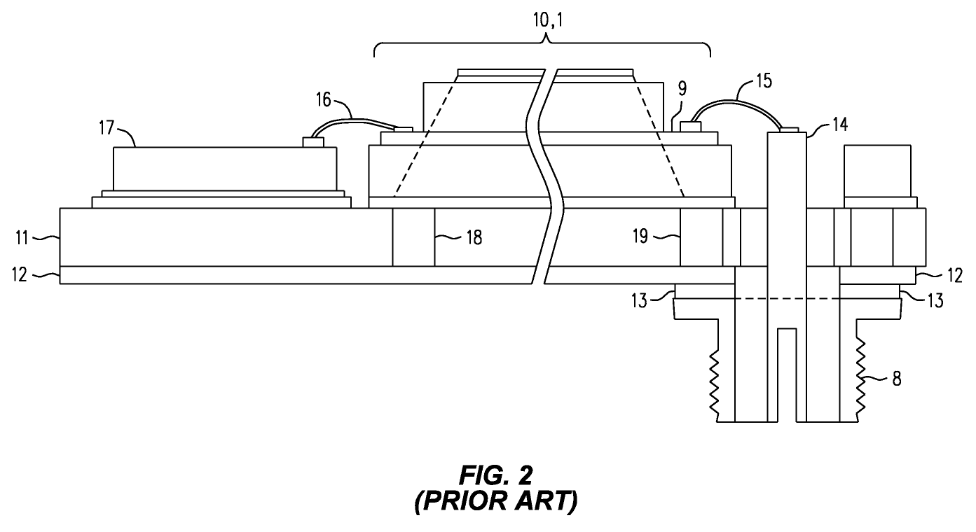

Refer now to FIG. 1, wherein is shown a simplified cross sectional view of a quasi-coaxial transmission line 1 fabricated upon a substrate 2 with thick film techniques as taught in the incorporated '730 B1 and '979 B1 patents. (In fact, this and the next paragraph have been robbed from '979 and then re-worked to serve here.) In particular, note the ground plane 3, deposited on the “top” of the substrate 2 (i.e., on the same side as the transmission line 1), and which, as ground planes do, may extend liberally in all directions as needed. The ground plane may be of metal, preferably gold, and if patterns therein are needed, an etchable thick film Au process, such as the Heraeus KQ-500 may be used. The quasi-coaxial transmission line 1 itself includes a layer or strip 4 of KQ dielectric material, that meanders as needed for the desired path of the transmission line.

As an aside, it will readily be appreciated that although we will often use the specific term “KQ” to refer to thick film dielectric materials, it should also be understood that our intent is to refer to any low loss, low dielectric constant thick film material compatible with the underlying substrate material and the quasi-coaxial transmission line and associated structures to be built-up. For example, there is a family of similar materials from Du Pont that will be mentioned in due course.

To continue, then, once that layer or strip 4 is in place, a suitable layer or strip of metal 5 (which is preferably Au) is deposited on the top surface of the strip 4. This strip of metal 5 is the center conductor of the quasi-coaxial transmission line (and is what needs to be connected to various things at either end). Subsequently, a second layer or covering strip of KQ dielectric 6 is deposited onto the top surface of layer 4, enclosing the center conductor 5. Finally, an enclosing layer of metal 7 (preferably Au) is deposited over the combined KQ strips 4 and 6, with the result that the center conductor 5 is completely surrounded by ground, and thus becomes a quasi-coaxial transmission line. The characteristic impedance of the quasi-coaxial transmission line 1 is determined in a known manner by the dielectric constant of the KQ material and the dimensions of the KQ strips or layers 4 and 6, in conjunction with the width of the center conductor 5. Thus, the quasi-coaxial transmission line 1 may be fabricated to have a particular characteristic impedance, such as 50Ω, or perhaps 75Ω, as desired. The task ahead is to suitably connect the quasi-coaxial transmission line 1 to an appropriate connector, such as one whose form factor mates with a suitable microwave connector.

Before proceeding, however, a brief note is in order concerning the ground plane 3. As a true ground plane it will perform best if it is indeed a broad sheet of metal, and that is what the figure shows. On the other hand, the portions of such a ground plane not beneath the quasi-coaxial transmission line 1 do not afford any particular benefit to the transmission line, insofar as it is a transmission line considered in isolation. The situation may become more complex if there are other circuits located to one side of the transmission line that require strong RF currents to be carried in a ground plane; good practice would be to keep such currents out of the shield for the transmission line. In any event, it may be desirable to not have an entire plane of metal serving as ground. In an extreme such case only the path of the transmission line needs to have a sufficiently wide ground put down before the quasi-coaxial transmission line is fabricated on top thereof.

Refer now to FIG. 2, wherein is shown a side view of a prior art technique for radially connecting an RF connector 8 to the center conductor 9 of a quasi-coaxial transmission line (10,1). In this particular arrangement the quasi-coaxial transmission line 10 is essentially the same as that (1) shown in FIG. 1, while some additional items are depicted. Those additional items include some source or destination circuitry 17 (e.g., an output buffer or driver, or, a receiver or pre-amplifier) that is connected to the center conductor 9 by a wire bond 16. Both the circuitry 17 and the quasi-coaxial transmission line (10, 1) are carried on the ‘top side’ a substrate 111 that may have a ground plane 12 on its ‘bottom side’. Note the occasional vias 18 and 19 that (if they are needed) ensure that the ‘outer shield’ of the quasi-coaxial transmission line is adequately grounded. It will be appreciated that the length of the quasi-coaxial transmission line (10, 1) might be much longer than its size relative to the other items in the figure would seem to indicate.

Also shown in FIG. 2 is a radially mounted connector 8, which might be any suitable RF or microwave connector 8, whether of the threaded or push-on variety. The outer shell, or body, of the connector 8 is attached (13) to the ground plane 12 with solder or conductive epoxy. The center conductor 14 of the connector 8 extends through a hole in the substrate to a location opposite a distal end of the center conductor 9, and the two (9, 14) are electrically connected with a wire bond 15.

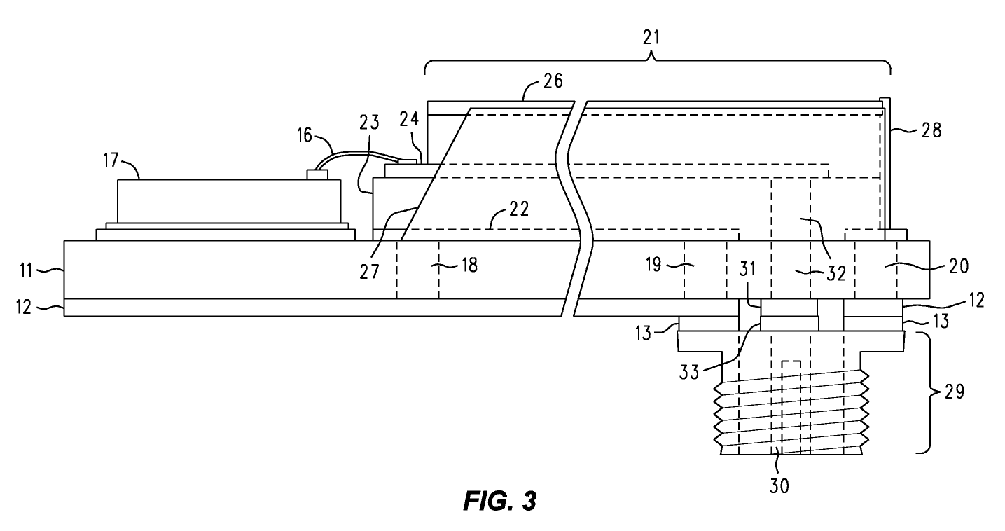

Now consider the arrangement whose side view is shown in FIG. 3. In FIG. 3, those elements that are essentially the same as in FIG. 2 will be denoted by unchanged reference numerals, and while they may be referred to, will not require re-explanation. To continue, then, note that the body of the connector 29 (which may be any suitable RF or microwave connector, whether male or female, threaded or push-on, etc.) is attached (33, 13) to the ground plane 12 (or, perhaps only to lands that are a portion thereof) and to a signal land 31 with solder or conductive epoxy. Observe that the connector's center conductor no longer extends into the substrate 11 toward the center conductor 24 of the quasi-coaxial transmission line 21. Instead, an abbreviated center conductor 30 ends flush with the rest of the connector and is connected (33) also by solder or conductive epoxy to a metallic land 31 and thence to a conductive via 32 that does extend into the substrate and is electrically connected to the center conductor 24. (We have not shown a Teflon bushing or other device that keeps the abbreviated center conductor 30 in place prior to assembly to the substrate; presumably there is something, but its exact nature will depend upon the nature of the particular connector 29 . . . )

To conclude our discussion of FIG. 3, note the following additional items. Conductive vias 18, 19 and 20 ensure that shielding surfaces (which are deposited layers of metal, such as gold) 22 (a bottom shield), 26 (a top shield), 27 (a side shield, and there is one on each side) and 28 (an end shield) are all adequately connected to ground. Finally, it will become clear that the substrate 11 might be of alumina or of aluminum nitride. Alumina is a long standing favorite in the thick film industry, and the KQ products from Heraeus Cermalloy are well suited for use as adjunct materials with alumina. Aluminum nitride (ALN) on the other hand, is expensive (owing to low demand) and notoriously difficult to work with, mainly because the usual adjunct materials have a different coefficient of thermal expansion that gives rise to issues of poor adhesion and cracking under temperature extremes. Nevertheless, the compelling excellence of aluminum nitride is its thermal conductivity (many times that of alumina) and this has led to the development of a family of products from Du Pont that are suitable for use with aluminum nitride in those applications where performance outweighs the cost (think: military and space vehicle applications).

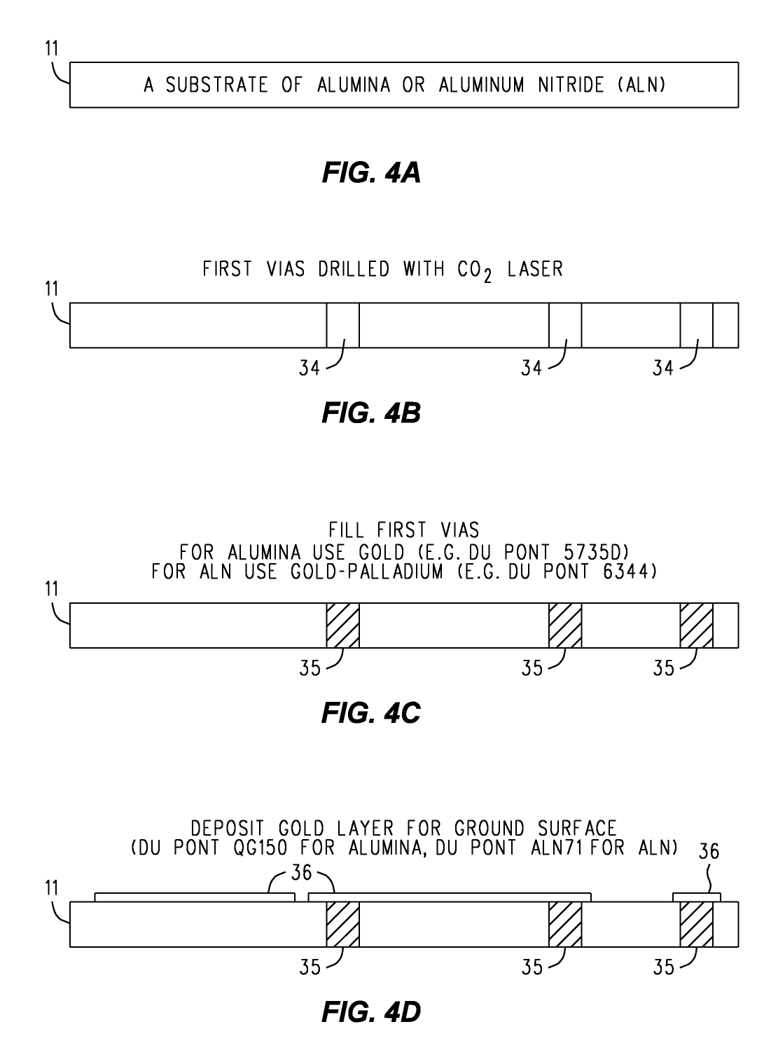

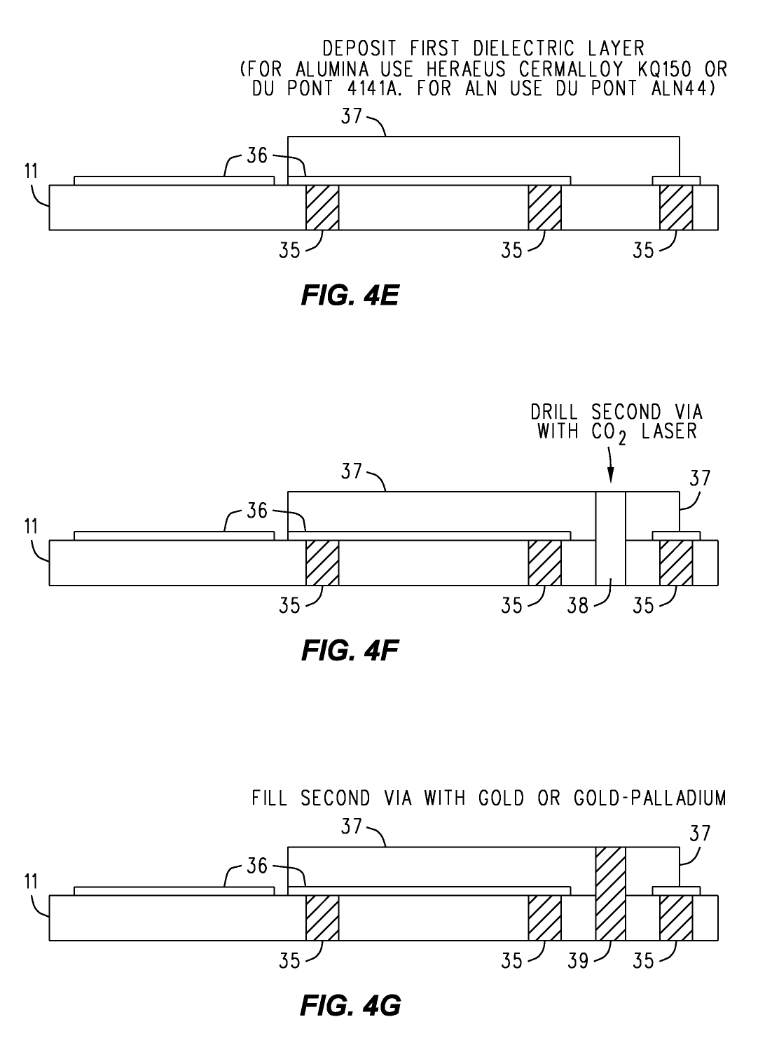

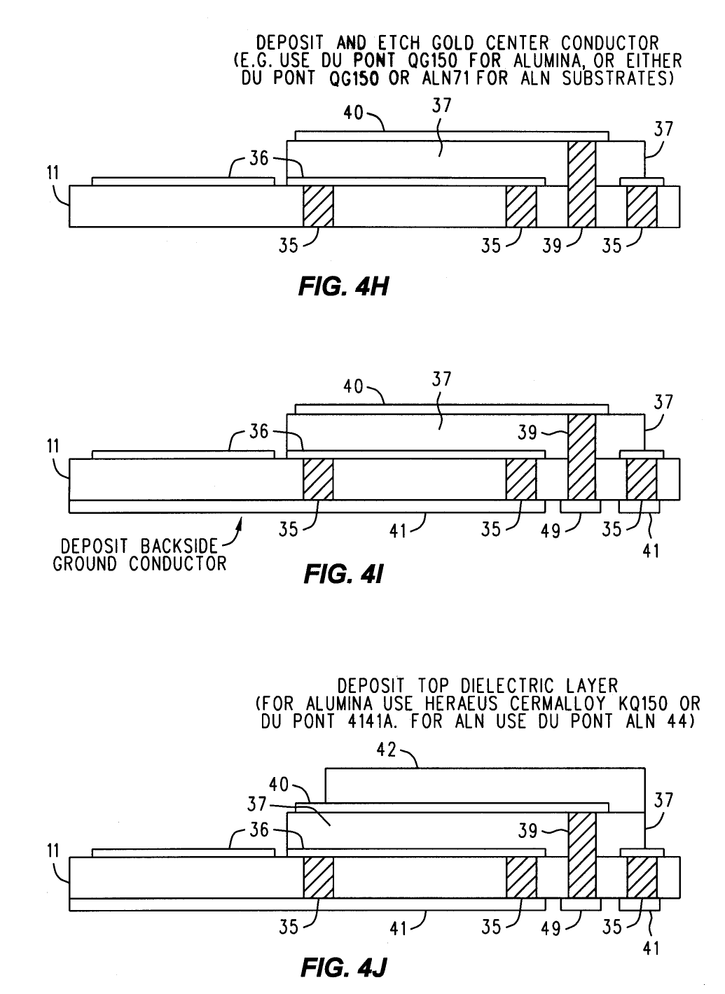

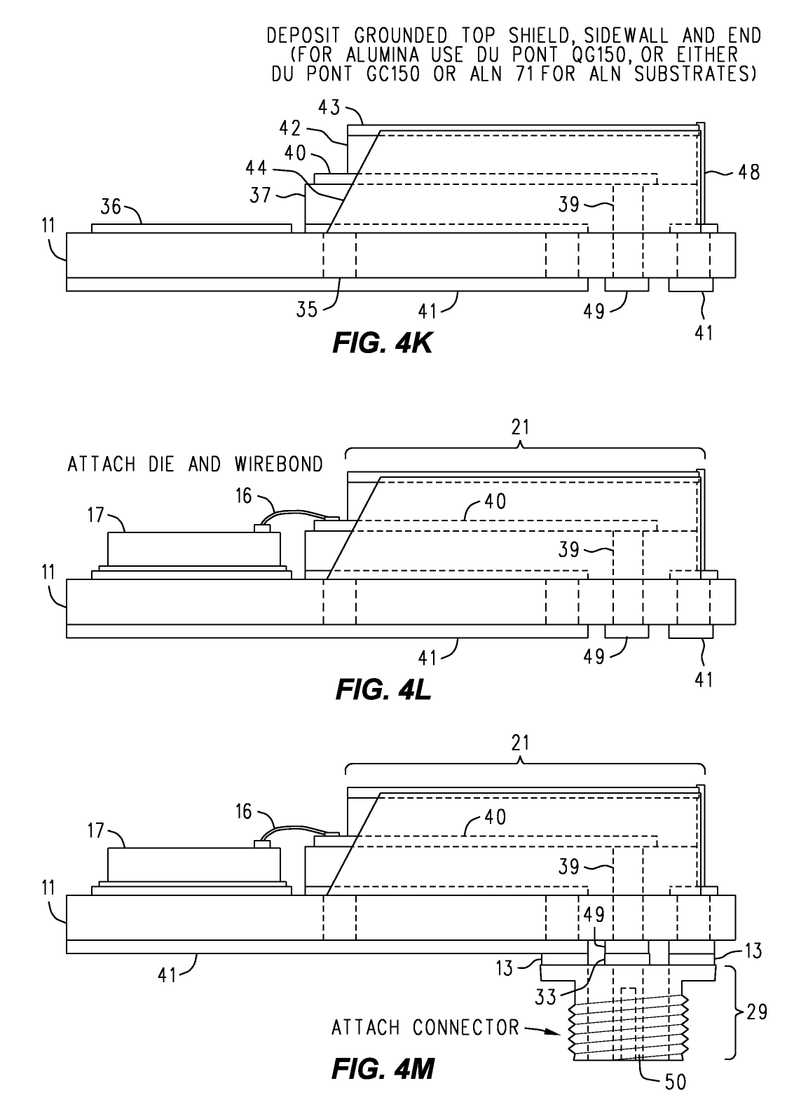

We turn now to a simplified explanation of the processing steps that may be used to fabricate the arrangement shown in FIG. 3. In the interest of brevity, we shall take recourse to the following simplification. The significant steps of interest are shown in FIGS. 4A-4M. We shall refer to steps A-M, with the understanding that the corresponding figure illustrates the step of interest. Furthermore, it will be appreciated that the manufacturers of the materials involved (Heraeus Cermalloy, Du Pont) each publish information about the various parameters involved in accomplishing the various operations needed for using their materials. For instance, the dielectric KQ stuff from Heraeus Cermalloy usable with alumina needs to be ‘fired’ (baked) to cure it from a paste into a solid. The nature of the oven (an air furnace, preferably with a conveyor belt), the peak temperature (850° C.) and the firing time are all known from Heraeus Cermalloy's literature, and these parameters are both verifiable and modifiable through readily obtained experience. A similar situation exists for the Du Pont products for use with aluminum nitride. The figures themselves have legends that indicate with products to use for the different substrates.

To continue, then, FIG. 4A shows a substrate 11 with which to begin the process of creating a quasi-coaxial transmission line 21 that has a radial butt-mount coaxial connection through the substrate, and which substrate might be of alumina or of aluminum nitride. The use of other types of substrates is not excluded, but the accompanying adjunct materials identified for use in the subsequent steps are known to work these particular substrates. Whether or not the identified adjunct materials will work with some other substrate cannot always be said ahead of time, although the general progression of the steps would remain essentially the same, even with a different type of substrate and accompanying materials.

FIG. 4B shows the step B of drilling of a collection of first vias 34. These vias 34 may be drilled by ablation using a CO₂ laser, in a conventional and known manner. The number and locations of vias 34 will be determined by the particular layout at hand for the desired quasi-coaxial transmission line. The basic purpose of the vias 34 is, if necessary or desirable, to ensure that the outer shield of the quasi-coaxial transmission line is adequately grounded. We can imagine circumstances where there might not be any vias 34, as well as some where there are many.

In step C of FIG. 4C the various vias 34 are filled with metal to become filled first vias 35. The metal filling may be gold for alumina and gold-palladium for aluminum nitride.

In step D of FIG. 4D a ground surface 36 of gold is deposited on a ‘top side’ of the substrate 11 (i.e., a side that is to receive a quasi-coaxial transmission line—which might be both sides if there were to be a quasi-coaxial transmission line on each side!). This ground surface might indeed be an expansive planar sheet (a ‘ground plane’), or, it might be just a strip that meanders as needed and of a width sufficient to allow the subsequent fabrication thereon of the balance of the quasi-coaxial transmission line. Note that the ground surface 36 makes electrical contact with filled first vias 35.

In step E of FIG. 4E a strip (that meanders or not, as needed) of first dielectric layer 37 is deposited over the ground surface 36. This layer 37 will serve to isolate the center conductor (40 of FIG. 4H) from the various grounds that will surround it to form the quasi-coaxial transmission line 21, as well as helping to determine (by its thickness and dielectric constant) the characteristic impedance Z₀ (which might be, say, 50Ω or 75Ω) of the quasi-coaxial transmission line (21).

In step F of FIG. 4F a second via 38 is drilled with a suitable technique, such as the use of a CO₂ laser. It is through this hole that the ‘radial connection’ to the center conductor (40) will occur.

In step G of FIG. 4G the second via 38 is filled with metal (as in FIG. 4C) to become a filled second via 39.

In step H of FIG. 4H the metallic center conductor 40 is deposited onto the first dielectric layer 37, and (if necessary) etched. Note that center conductor 40 will then be in electrical contact with filled second via 39.

In step I of FIG. 4I a ‘backside’ ground conductor 41 is deposited on the side of the substrate 11 that is opposite the one that receives the quasi-coaxial transmission line 21. This (41) might be an actual expansive ground plane, or some subset of that which might include various lands through which other items are connected to ground. Deposition of conductor 41 will also include the deposition of isolated signal land 49 (definitely not to be a ground!) that will be in electrical contact with center conductor 40 through the intervening filled second via 39.

In step J of FIG. 4J a top, or second, dielectric layer 42 is deposited over the center conductor 40 and the first dielectric layer 37. This layer (42) will serve to insulate the center conductor from the eventual top grounded shield (43 of FIG. 4K), as well as contributing to the characteristic impedance Z₀ of the quasi-coaxial transmission line (21).

It is clear that the order of steps J of FIGS. 4J and I of FIG. 4I might be interchanged.

In step K of FIG. 4K a grounded top shield 43, grounded sidewalls (two of 44, only one of which is visible) and a grounded end 48, each of metal, are deposited over the first and second dielectric layers (37 & 44). This accomplishes the ‘encapsulation’ of the center conductor 40, as set out in the incorporated patents, and actually creates a controlled impedance transmission line whose center conductor extends to signal land 49.

In step L of FIG. 4L the die 17 is attached to the substrate 11, and then a wire bond 16 is applied (or perhaps another connection technique is used) to electrically connect the center conductor 40 to the circuitry within the die 17.

In step M of FIG. 4M the connector 29 is attached (33, 13) with solder or conductive epoxy to the signal land 49 and the ground surface 41. This grounds the outer shell of the connector 29 to the outer shield of the quasi-coaxial transmission line 21, as well as electrically connects the (male or female) center pin 50 of connector 29 to signal land 49 (which electrically connects the center pin 50 of connector 29 to center conductor 40 of the quasi-coaxial transmission line 21).

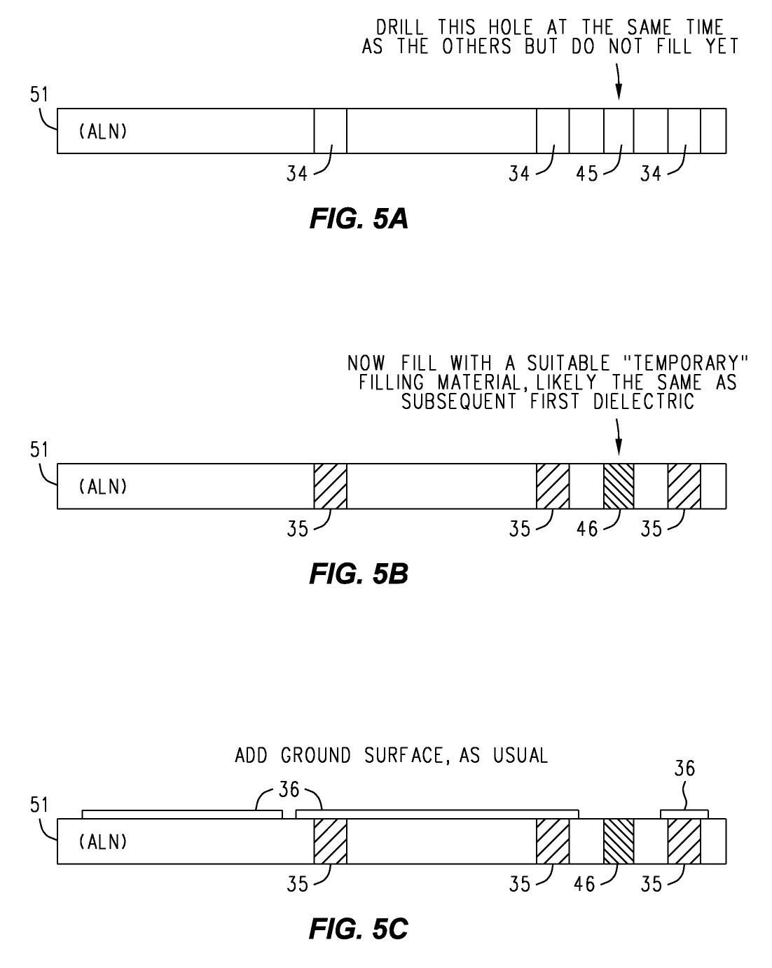

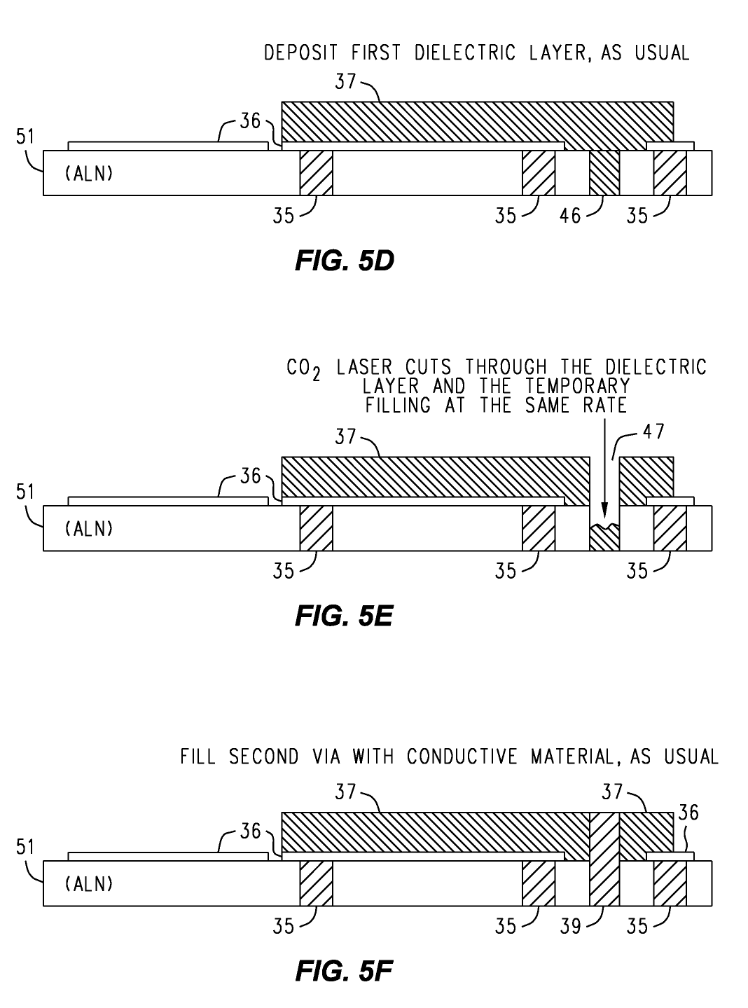

Finally, refer now to FIG. 5A-5F. The series of steps depicted therein are useful when there is a significant difference in the behavior of the substrate material (11, 51) and the dielectric material used for the first dielectric layer (37). An example of a problem that can be solved by these steps is this: Suppose that the substrate material is aluminum nitride. Its superior thermal conductivity can mean that much more laser power is needed to drill second via 38 through the first dielectric layer 37 and substrate 11 (refer to FIG. 4F). It might not matter from which side the drilling is attempted; the extra time (think: total heat) required to drill the ALN (its rate of ablation is significantly lower than for the layer 37) might cause deformation, sagging or droop in the layer 37, owing to overheating. Rats. What to do?

In the step of FIG. 5A the required second via hole 45 is drilled in the substrate 51 at the same time as the first vias (34) but BEFORE any layers of dielectric material have been deposited. (That which has NOT YET been deposited cannot sag or droop . . . )

In the step of FIG. 5B the various vias 34 and 45 are filled to become filled vias 35 and 46, respectively. Vias 34 are filled as before (with metal), but via 45 is preferably filled with the material used to create the first dielectric layer (37).

In the steps of FIG. 5C the ground surface 36 is deposited, as before (as in FIG. 4D).

In the steps of FIG. 5D the first dielectric layer 37 is deposited, as usual (as in FIG. 4E).

In the step of FIG. 5E the second via 47 is re-drilled with the laser, but this time all the material is of the same composition, and ablation occurs without overheating the balance of the cured first dielectric layer 37, since no ALN needs to be removed (its already gone!).

Finally, in FIG. 5F the re-drilled hole is filled with metal to become the desired filled second via 39 (compare to FIG. 4G). Now the balance of the steps can proceed as from those of FIG. 4H. Voila'.

We claim:

1. An apparatus comprising:
a substrate having first and second parallel surfaces;
a quasi-coaxial transmission line fabricated upon the first surface, having a center conductor, a surrounding outer shield and also having first and second distal ends;
the center conductor at the second distal end of the quasi-coaxial transmission line for electrical connection to a work circuit;
a conductive signal via proximate the first distal end, the conductive signal via being underneath and in electrical contact at one end with, the center conductor and also extending through a hole in the substrate to align at its other end with the second surface;
a signal land of metal deposited on, and in electrical contact with, the other end of the conductive signal via and extending outward onto a region of the second surface surrounding the conductive signal via;
at least one conductive ground via in the substrate proximate the first distal end and in electrical contact at one end with the outer shield;
at least one ground land of metal deposited on, and in electrical contact with, the other end of the conductive ground via and extending outward onto a region of the second surface surrounding the conductive ground via;
a butt-mounted coaxial connector having a center pin electrically and mechanically attached to the signal land and an outer shell electrically and mechanically attached to the at least one ground land.

2. Apparatus as in claim 1 wherein the substrate is of alumina and the quasi-coaxial transmission line includes dielectric materials from Heraeus Cermalloy.

3. Apparatus as in claim 1 wherein the substrate is of aluminum nitride and the quasi-coaxial transmission line includes dielectric materials from Du Pont.

4. Apparatus as in claim 1 wherein the characteristic impedance of the quasi-coaxial transmission line is 50Ω.

5. A method of creating a hole through a substrate and also through a layer of deposition material deposited thereon, the method comprising the steps of:
(a) ablating material of the substrate with a laser to create at the location of the desired hole a temporary hole of about the same size as the desired hole;
(b) filling the temporary hole with deposition material;
(c) depositing a layer of deposition material on a region of the substrate that includes the location of the desired hole; and
(d) ablating with a laser the deposition material at the location of the temporary hole until there is a hole through both the substrate and the layer of deposition material.

6. A method as in claim 5 further comprising the step of;
(e) filling the hole of step (d) with a conductive material.

7. A method as in claim 6 further comprising the step of forming a quasi-coaxial transmission line on the side of the substrate upon which the layer of deposition material is deposited on, and whose center conductor is in electrical contact with the conductive material of step (e).

8. A method as in claim 7 further comprising the step of butt-mounting a coaxial connector to an opposite side of the substrate and with its center conductor in electrical contact with the conductive material of step (e).
